(19) United States
(12) Patent Application Publication
(10) Pub. No.: US 2016/0140157 A1
(43) Pub. Date: May 19, 2016

(54) AESTHETICS DATA IDENTIFICATION AND EVALUATION

(71) Applicant: International Business Machines Corporation, Armonk, NY (US)

(72) Inventors: Ying Li, Mohegan Lake, NY (US); Anshul Sheopuri, Teaneck, NJ (US)

(21) Appl. No.: 14/541,283

(22) Filed: Nov. 14, 2014

(51) Int. Cl. G06F 17/30; G06K 9/46; G06T 7/00; G06T 7/40

(52) U.S. Cl. CPC G06F 17/30345; G06T 7/408; G06K 9/46; G06T 7/0081; G06F 17/3025; G06F 17/30262; G06T 2207/10024; G06T 2207/20148

(57) ABSTRACT

Evaluating aesthetics of image data is disclosed. Evaluating aesthetics of image data can include identifying a first set of aesthetics data from a first set of image data. Evaluating aesthetics of image data can include generating an aesthetics evaluation score for the first set of image data, the aesthetics evaluation score generated based on the first set of aesthetics data and a first set of aesthetics data rules. Evaluating aesthetics of image data can include determining that the aesthetics evaluation score achieves an aesthetics threshold. Evaluating aesthetics of image data can include endorsing the first set of image data in response to determining that the aesthetics evaluation score achieves the aesthetics threshold.

### BACKGROUND

The present disclosure relates to aesthetics data evaluation, and more specifically, to computer-implemented aesthetics evaluation of a set of image data.

Controlling, measuring, and designing an aesthetic appearance of an item can help influence the appeal of the item to a user. For example, in the food industry, the aesthetic appearance of food can determine, in part, whether the food is appealing visually and can affect other senses such as the user's appetite. In an additional example, in webpage design, the aesthetic appearance of a webpage can influence a user's perception of an organization or person associated with the webpage. For example, the visual appeal could influence a user's perception of an organization's quality, trustworthiness, or other characteristic.

### SUMMARY

According to embodiments of the present disclosure, a computer-implemented method of evaluating aesthetics of image data is disclosed. The method can include identifying a first set of aesthetics data from a first set of image data. The method can include generating an aesthetics evaluation score for the first set of image data, the aesthetics evaluation score generated based on the first set of aesthetics data and a first set of aesthetics data rules. The method can include determining that the aesthetics evaluation score achieves an aesthetics threshold. The method can include endorsing the first set of image data in response to determining that the aesthetics evaluation score achieves the aesthetics threshold.

Embodiments of the present disclosure are directed towards a system of evaluating aesthetics of image data. The system can include an aesthetics identification module and a processor. The aesthetics identification module can be configured to identify a first set of aesthetics data from a first set of image data. The processor can be configured to generate an aesthetics evaluation score for the first set of image data, the aesthetics evaluation score generated based on the first set of aesthetics data and a first set of aesthetics data rules. The processor can be configured to determine that the aesthetics evaluation score achieves an aesthetics threshold. The processor can be configured to endorse the first set of image data in response to determining that the aesthetics evaluation score achieves the aesthetics threshold.

Embodiments of the present disclosure are directed towards a computer program product for evaluating aesthetics of image data. The computer program product can include a computer readable storage medium having program instructions embodied therewith. The program instructions can be executable by a computer to cause the computer to perform a method. The method can include identifying a first set of aesthetics data from a first set of image data. The method can include generating an aesthetics evaluation score for the first set of image data, the aesthetics evaluation score generated based on the first set of aesthetics data and a first set of aesthetics data rules. The method can include determining that the aesthetics evaluation score achieves an aesthetics threshold. The method can include endorsing the first set of image data in response to determining that the aesthetics evaluation score achieves the aesthetics threshold.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system 100 for aesthetics data evaluation, according to embodiments of the present disclosure.

FIG. 2 depicts a system architecture 200 for aesthetics data evaluation, according to embodiments of the present disclosure.

FIG. 3 depicts a system architecture 300 for visual evaluation, according to embodiments of the present disclosure.

FIG. 4 depicts a system architecture 400 for texture data evaluation, according to embodiments of the present disclosure.

FIG. 5 depicts a system architecture 500 for uniqueness evaluation, according to embodiments of the present disclosure.

FIG. 6 depicts a system architecture 600 for aesthetics recommendation, according to embodiments of the present disclosure.

FIG. 7 depicts a flowchart diagram of a method 700 of visual evaluation, according to embodiments of the present disclosure.

FIG. 8 depicts a flowchart diagram of a method 800 of texture evaluation, according to embodiments of the present disclosure.

FIG. 9 depicts a flowchart diagram of a method 900 of uniqueness evaluation, according to embodiments of the present disclosure.

FIG. 10 depicts a diagram 1000 of color data identification, according to embodiments of the present disclosure.

FIG. 11 depicts a diagram 1100 of visual appeal evaluation, according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to aesthetics data evaluation, more particular aspects relate to aesthetics data extraction and evaluation based on aesthetics data rules. While the present disclosure is not necessarily limited to such applications, various aspects of the disclosure may be appreciated through a discussion of various examples using this context.

While various numbers may be used to identify same named elements within disclosure, this practice is not intended to limit the scope of the disclosure. Identified elements in one figure may be the same or substantially similar to other same named elements in other figures.

Embodiments of the present disclosure are directed towards a system configured to conduct aesthetics evaluations to help measure, design and control the aesthetic appeal of various items. Controlling, measuring, and designing an aesthetic appearance of an item can influence the appeal of the item to a user. For example, in the food industry, the aesthetic appearance of food can determine, in part, whether the food is appealing visually and can affect other senses such as the user's appetite. In an additional example, in webpage design, the aesthetic appearance of a webpage can influence a user's perception of an organization or person associated with the webpage. For example, the visual appeal could influence a user's perception of an organization's quality, trustworthiness, or other characteristic.

Consistent with embodiments of the present disclosure, aesthetics evaluation can include identification of various aesthetic characteristics, such as color, texture, uniqueness, and other characteristics of the item. In embodiments, aesthetic characteristics can be identified from aesthetics data. In embodiments, aesthetics data is data identified from the item that is related to aesthetic appeal of the item. In embodiments, the system can identify aesthetics data from a set of image data corresponding to the item. The set of image data can include various types of data that corresponds to a visual electronic representation of the item. For example, the set of image data could include color data for various pixels in an electronic display.

In some embodiments, aesthetics data can include color data identified from the set of image data. Color data can be data representations of colors present in the set of image data. In embodiments, the color data can be represented in various color models such as RGB, CMYK, and other suitable color models. In embodiments, aesthetics data can include texture data identified from the set of image data. Texture data, described further herein, can be data representations of various texture parameters such as such as measurements of coarseness, directionality, Gabor, and edge identification. In certain embodiments, other suitable types of aesthetics data can be used.

In embodiments, the aesthetics evaluation can include a visual evaluation of the item. The visual evaluation can include analysis of color data in the set of image data to identify aesthetic characteristics including, but not limited to, visual appeal, color schemes, color diversity, and color intensity. In embodiments, the visual evaluation can be a color evaluation of the item. Described further herein, in embodiments, the aesthetics evaluation could include a texture evaluation of the item. The texture evaluation can include analysis of texture data in the set of image data to identify aesthetic characteristics relating to texture. Described further herein, in some embodiments, the aesthetics evaluation could include a uniqueness evaluation. The uniqueness evaluation can include analysis of color data in the set of image data to identify aesthetic characteristics relating to uniqueness.

In embodiments, the system can be configured to generate an aesthetics evaluation score. The aesthetics evaluation score can be a numerical value representing aesthetic appeal of the image. In embodiments, the system can be configured to generate the aesthetics evaluation score based on the aesthetic characteristics identified in aesthetics evaluation of the set of image data. In embodiments, the aesthetics evaluation score can be based on a set of aesthetics data rules.

In embodiments, the aesthetics data rules are a set of aesthetics preferences which can determine, in part, how the system scores the aesthetic appeal of the image. For example, the aesthetics data rules could include a preference that the set of color data include one or more color schemes such as an analogous colors and complementary colors. Based on the aesthetics evaluation, the system can identify whether the image satisfies the aesthetics preferences. For example, the system could identify from the aesthetics evaluation that the set of image data includes analogous colors and complementary colors. Thus, the set of image data would satisfy aesthetic preferences for those color schemes. In embodiments, the more aesthetic preferences satisfied by aesthetics data, the higher the aesthetics evaluation score for the item.

In embodiments, the aesthetics data rules can be selected to be related to the image data. For example, if the image data is a representation of food, the aesthetics data rules could be specific to the realm of food. In certain embodiments, the aesthetics data rules could be selected by a user.

In embodiments, the system can be configured to endorse or reject the set of image data based on a comparison of the aesthetics evaluation score to an aesthetics threshold. In embodiments, the aesthetics threshold can be a value selected to indicate when the aesthetics evaluation score is sufficiently high enough for the system to endorse the set of image data as aesthetically appealing. In embodiments, if the aesthetics evaluation score achieves the threshold, the system can be configured to endorse the set of image data. If the aesthetics evaluation score does not achieve the threshold, the system can be configured to reject the set of image data. In embodiments, the aesthetics score achieves the threshold when it exceeds the threshold. In certain embodiments, the aesthetics score achieves the threshold when it is within the threshold.

Described further herein, in embodiments, the aesthetics evaluation score can include various scores related to aesthetics of the set of image data. In embodiments, the aesthetics evaluation score can include a visual evaluation score. In embodiments, the visual evaluation score can be a color evaluation score. In embodiments, the aesthetics evaluation score can include a texture evaluation score. In embodiments, the aesthetics evaluation score can include a uniqueness evaluation score. Similarly, in embodiments, the aesthetics threshold can include various thresholds. In embodiments, the aesthetics threshold can include a visual threshold. In embodiments, the visual threshold can be a color threshold. In embodiments, the aesthetics threshold can include a texture threshold. In embodiments, the aesthetics threshold can include a uniqueness threshold.

Embodiments of the present disclosure are directed towards a system configured to conduct visual evaluation of image data. The system can be configured to receive a set of image data associated with an item. The system can be configured to identify a set of color data from the set of image data. In embodiments, the set of color data can include a set of distinct colors. In embodiments, the set of color data can include a set of quantized colors, described further herein. Based on the set of color data and a set of aesthetics data rules, the system can be configured to generate a visual evaluation score for the set of image data.

As described herein, the visual evaluation score can be generated based on whether the set of color data satisfies preferences in the aesthetics data rules. In embodiments, the more aesthetic preferences satisfied, the higher the visual evaluation score. In embodiments, the system can be configured to endorse or reject the set of image data based on whether the visual evaluation score achieves a visual threshold.

Embodiments of the present disclosure are directed towards a system configured to conduct texture data evaluation. The system can be configured to identify a first set of texture data from a set of image data. Described further herein, the set of texture data can include various texture parameters such as measurements of coarseness, directionality, Gabor, and edge identification.

The system can be configured to generate a texture evaluation score for the set of image data based on the set of aesthetics data rules and based on a texture difference between the first set of texture data and a second set of texture data. Described further herein, the texture difference can be a value based a comparison between various texture parameters in the first set and second set of texture data.

In embodiments, the system can be configured to endorse or reject the image data based on whether the texture evaluation score achieves a texture threshold.

Embodiments of the present disclosure are directed towards a system configured to conduct uniqueness evaluation. The system can be configured to identify a first set of color data from the image data. The system can be configured to generate a uniqueness evaluation score for the set of image data. The uniqueness evaluation score can be based on the set of aesthetics data rules and generated based on a color difference between the first set of color data and a second set of color data.

In embodiments, the system can be configured to endorse or reject the image data based on whether the uniqueness evaluation score achieves a uniqueness threshold.

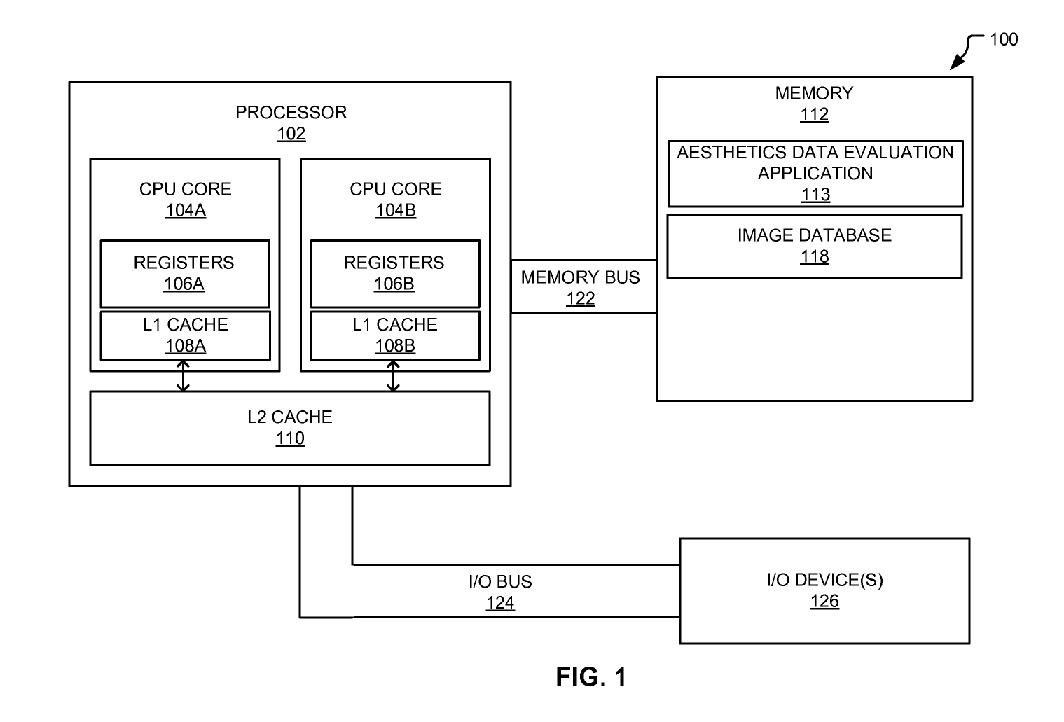

Referring now to FIG. 1, a system for aesthetics data evaluation can be seen according to embodiments of the present disclosure. In embodiments, the system 100 can include a processor 102, memory 112, and I/O (input/output) device(s) 126.

The processor 102 can execute instructions stored in memory 112 and perform various functions in the computer processing system 100. The processor 102 can include CPU cores 104A, 104B. In embodiments, the processor 102 can contain a plurality of CPU cores. In certain embodiments, the processor 102 can contain a single CPU core. Each of the CPU cores 104A, 104B can include respective registers 106A, 106B, and respective L1 caches 108A, 108B. The CPU cores 104A, 104B can retrieve and execute instructions from memory 112 and provide logic functions for the processor 102. The registers 106A, 106B and L1 cache 108A, 108B can provide storage for data that frequently accessed in each CPU core 104A, 104B. The processor 102 can also include L2 cache 110. The L2 cache 110 can be communicatively connected to each of the CPU cores 104A, 104B and can provide shared storage for data in the processor 102.

In embodiments, the system 100 can contain multiple processors 102 typical of a relatively large system. In certain embodiments, the computer system 100 can be a single processor system. The processor 102 can be various types of processors including, but not limited to digital signal processor (DSP) hardware, network processor, application specific integrated circuit (ASIC), field programmable gate array (FPGA), or other types of processors. The memory 112 can be coupled to the processor 102 via a memory bus 122.

The memory 112 can include a random-access semiconductor memory, storage device, or storage medium (either volatile or non-volatile) for storing or encoding data and programs. The memory 112 can be conceptually a single monolithic entity, but in other embodiments the memory 112 can be a more complex arrangement, such as a hierarchy of caches and other memory devices. The memory 112 can store data, instructions, modules, and other types of information, hereafter collectively referred to as “memory elements.” Although the memory elements are illustrated as being contained within the memory 112, in certain embodiments some or all of them can be on different devices and can be accessed remotely, e.g., via a network.

The system 100 can use virtual addressing mechanisms that allow the programs of the computer system 100 to behave as if they only have access to a large, single storage entity instead of access to multiple, smaller storage entities. Thus, while the memory elements are illustrated as being contained within the memory 112, these elements are not necessarily completely contained in the same storage device at the same time. Further, although the memory elements are illustrated as being separate entities, in other embodiments some of them, portions of some of them, or all of them can be packaged together.

In embodiments, the memory elements can include an aesthetics data evaluation application 113 and an image database 118. In embodiments, the aesthetics data evaluation application 113 can instruct the system 100 to perform embodiments of the present disclosure, as described herein. For example, in embodiments, the aesthetics data evaluation application could instruct the system to conduct visual evaluation, texture data evaluation, and uniqueness evaluation, as described herein.

The processor 102 can also communicate with one or more I/O devices 126 via an I/O bus 124. The I/O devices 126 can include, but are not limited to, devices such as a keyboard, a pointing device, a display, one or more devices that enable a user to interact with the computer system 100, and various devices (e.g., network interface card, modem, etc.) that enable the computer system 100 to communicate with one or more other computing devices. It should be understood that other suitable hardware and software components can be used in conjunction with the computer system 100.

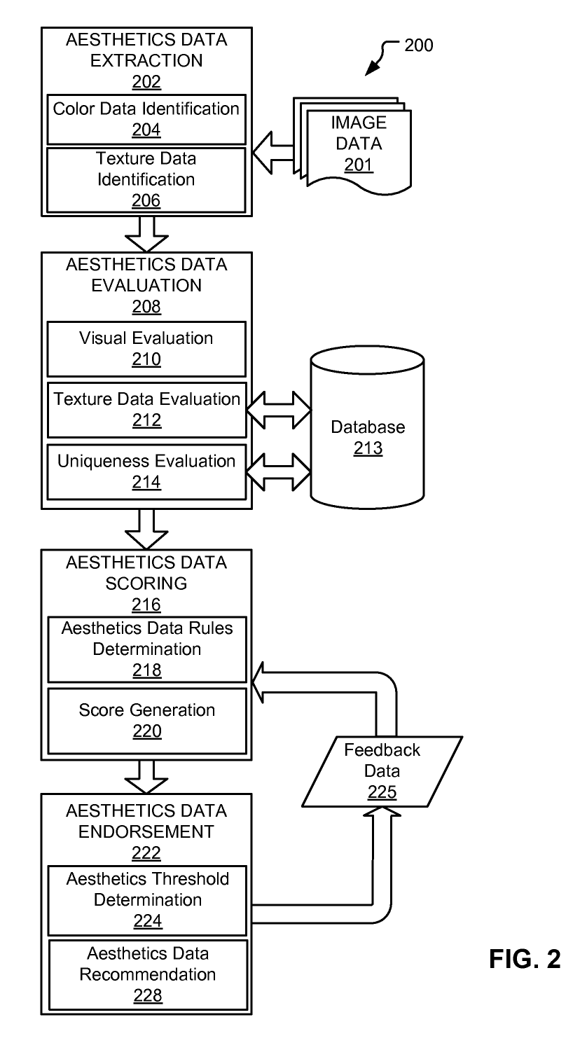

Referring now to FIG. 2, a system architecture 200 for aesthetics data evaluation can be seen according to embodiments of the present disclosure. In embodiments, the system architecture 200 can represent an example architecture for executing embodiments of the present disclosure. For example, in some instances, the system architecture 200 can be an example representation of the aesthetics data evaluation application 113 (FIG. 1).

In embodiments, the system architecture 200 can include an aesthetics data extraction system 202, an aesthetics data evaluation system 208, an aesthetics data scoring system 216, and an aesthetics data endorsement system 222.

The aesthetics data extraction system 202 can be configured to extract aesthetics data from image data for eventual scoring and evaluation by various systems and modules in the system architecture 200. Described further herein, the aesthetics data extraction system 202 can include a color data identification module 204 and a texture data identification module 206.

The color data identification module 204 can be configured to access image data 201 and identify a set of color data from the image data 201. Described further herein, the set of color data can include a set of distinct colors. In some embodiments, the set of color data can include a set of quantized colors. In embodiments, the color data can include proportions for colors in the color data. In embodiments, the module 204 can be configured to generate the set quantized colors from the set of distinct colors.

The texture data identification module 206 can be configured to access image data 201 and identify a set of texture data from the image data 201. Described further herein, the set of texture data can include one or more texture parameters. Texture parameters can be various measurements of texture characteristics present in the image data 201. In embodiments, the texture parameters can include, but are not limited to, measurements of coarseness, directionality, Gabor, and edge identification.

In embodiments, after aesthetics data has been extracted from the image data 201 the data can then be evaluated by the aesthetics data evaluation system 208.

The aesthetics data evaluation system 208 can be configured to evaluate aesthetics data from image data 201 for eventual scoring and possible endorsement by various systems and modules in the system architecture 200. Described further herein, the aesthetics data evaluation system 208 can include a visual evaluation module 210, a texture data evaluation module 212 and a uniqueness evaluation module 214.

The visual evaluation module 210 can be configured to analyze the set of color data identified from the image data 201. In embodiments, the visual evaluation module 210 can be configured to determine a visual appeal parameter for the set of color data. In embodiments, the visual appeal parameter can include various color parameters of the color data. In embodiments, determining visual appeal parameters can include determining color schemes in the color data. In some embodiments, determining the visual appeal parameter can include identifying a particular color type in the color data. For example, determining the visual appeal parameter could include identifying warm colors in the color data and/or identifying complementary colors in the color data. Described further herein, the identified color schemes can be used to determine a visual evaluation score for the set of color data in the aesthetics data scoring system 216.

In embodiments, the visual evaluation module 210 can be configured to determine a color diversity parameter for the set of color data. The color diversity parameter can be a representation of the variety of identified colors which make up the set of color data. For example, on a color wheel representation of a range of visible colors, the greater the radial distribution of colors of the color data on the color wheel, the greater the color diversity parameter.

In embodiments, the visual evaluation module 210 can be configured to determine a color intensity parameter for the set of color data. In embodiments, the greater the intensity of colors in the set of color data the greater the color intensity parameter. Described further herein, the visual appeal parameter, the color diversity parameter, and the color intensity parameter can be used to determine a visual appeal score.

The texture data evaluation module 212 can be configured to analyze the set of texture data identified from the image data 201. In embodiments the texture data evaluation module 212 can be configured to compare a first set of texture data to a second set of texture data. Based on the comparison, the texture data evaluation module 212 can determine a texture difference between the first set of texture data and the second set of texture data.

In embodiments, the first set of texture data can be the set of texture data identified from the image data 201. In certain embodiments, the second set of texture data can be a repository of texture data stored in a database 213.

In embodiments, the database 213 can store a plurality of color data, texture data and other data. The texture data evaluation module 212 can access the database 213 to determine a texture difference between the first set of texture data from image data 201 and a second set of texture data from the database 213. Described further herein, the texture difference can be used, in part, to determine a texture evaluation score for the image data 201.

The uniqueness evaluation module 214 can be configured to analyze the set of color data extracted from the image data 201. In embodiments, the module 214 can evaluate how unique the set of image data 201 is, relative to a repository of color data from a second set of image data. Described further herein, the uniqueness evaluation module 214 can be configured to compare a first set of color data to a second set of color data. The uniqueness evaluation module 214 can determine a color difference between the first set of color data and the second set of color data.

In embodiments, the first set of color data can be the set of color data identified from the image data 201. In certain embodiments, the second set of color data can be from a repository of color data stored in the database 213. Described further herein, the color difference can be used to determine a uniqueness evaluation score for the image data 201.

In embodiments, after aesthetics data from the image data 201 has been evaluated by the aesthetics data evaluation system 208, the data can then be sent to the aesthetics data scoring system 216.

The aesthetics data scoring system 216 can be configured to score aesthetics data for possible endorsement by various systems and modules in the system architecture 200. Described further herein, the aesthetics data scoring system 216 can include an aesthetics data rules determination module 218, and a score generation module 220.

The aesthetics data rules determination module 218 can determine a set of aesthetics data rules used for the image data 201. As described herein, the set of aesthetics data rules can be a set of aesthetic preferences. The aesthetic preferences can include, but are not limited to, a color diversity preference, a color intensity preference, visual appeal parameter preferences, texture preferences, uniqueness preferences, and other preferences. For example, a first set of aesthetic preferences could include a preference for a high color diversity parameter and a preference for a high color difference. In such a case, when the visual evaluation module 210 and the uniqueness evaluation module 214 determines a color diversity parameter and a color difference, the higher the color difference and the higher the color diversity parameter the more satisfied the first set of aesthetics data rules. In certain embodiments, the aesthetics data rules could include thresholds to determine whether the various preferences are satisfied.

In embodiments, the extent to which the set of image data 201 satisfies the aesthetic preferences affects the score generated by the score generation module 220. For example, for a first set of aesthetics data rules associated with food aesthetics, particular color schemes could be preferred such as an analogous color scheme and a complementary color scheme. Based on evaluation by the visual evaluation module 210, the system architecture 200 could determine that the set of image data 201 contains those color schemes. Described further herein, the existence of those color schemes could then affect the scoring of the image data 201 by the score generation module 220.

In embodiments, the set of aesthetics data rules can be selected by a user. For example, the user could select that image data 201 be analyzed according to the first set of aesthetics data rules. In certain embodiments, the system architecture 200 could be configured to automatically select the aesthetics data rules based on the image data 201. For example, the system could select a set of aesthetics data rules that was related to the set of image data 201 as described herein.

The score generation module 220 can be configured to generate a set of scores for the data evaluated by various systems and modules in the system architecture 200. In embodiments, the score generation module 220 can generate a visual evaluation score for the visual evaluation module 210. Described further herein, the visual evaluation score can be generated based a result generated by the visual evaluation module 210 and the aesthetics data rules.

In embodiments, the score generation module 220 can generate a texture evaluation score for the texture data evaluation module 212. Described further herein, the texture evaluation score can be generated based on the texture difference determined by the texture data evaluation module 212 and the aesthetics data rules.

In embodiments, the score generation module 220 can generate a uniqueness evaluation score for the uniqueness evaluation module 214. Described further herein, the uniqueness evaluation score can be generated based on a color difference determined by the uniqueness evaluation module 214 and based on the aesthetics data rules.

In embodiments, after aesthetics data from the image data 201 has been scored by the aesthetics data scoring system 216, the image data 201 can then be sent to the aesthetics data endorsement system 222.

The aesthetics data endorsement system 222 can be configured to endorse or reject the set of image data 201 based on the evaluation and scoring. The aesthetics data endorsement system 222 can include an aesthetics threshold determination module 224 and an aesthetics recommendation module 228.

The aesthetics threshold determination module 224 can compare the aesthetics scores generated by the aesthetics data scoring system 216 to various aesthetics thresholds. For example, in embodiments, the aesthetics threshold determination module 224 can compare the visual evaluation score to a visual threshold. The module 224 can be configured to endorse the set of image data 201 in response to determining that the visual evaluation score achieves the visual threshold. In embodiments, the module 224 can be configured to reject the set of image data 201 in response to determining that the visual evaluation score does not achieve the visual threshold. In some embodiments, a threshold is achieved when a score is above the threshold.

In certain embodiments, the aesthetics threshold determination module 224 can compare the texture evaluation score to a texture threshold. In embodiments, the module 224 can be configured to endorse the set of image data 201 in response to determining that the texture evaluation score achieves the texture threshold. In embodiments, the module 224 can be configured to reject the image data 201 in response to determining that the texture evaluation score does not achieve the texture threshold.

In certain embodiments, the aesthetics threshold determination module 224 can compare the uniqueness evaluation score to a uniqueness threshold. In embodiments, the module can be configured to endorse the set of image data 201 in response to determining that the uniqueness evaluation score achieves the uniqueness threshold. In embodiments, the module 224 can be configured to reject the image data 201 in response to determining that the uniqueness evaluation score does not achieve uniqueness threshold.

In certain embodiments, the aesthetics data endorsement system 222 can be configured to transmit feedback data 225 to the aesthetics data scoring system 216. The feedback data 225 can contain information regarding the aesthetics scores. In embodiments, the aesthetics data scoring system 216 that may use feedback data to refine the aesthetics data rules and/or score generation.

In embodiments, if the aesthetics data from the image data 201 has been rejected by the aesthetics data endorsement system 222, aesthetics data can be sent to the aesthetics data recommendation module 228.

Described further herein, the aesthetics data recommendation module 228 can be configured to provide aesthetics data recommendations for the set of image data 201 in response to rejection of color data from image data 201. For example, in embodiments, the aesthetics data recommendation module 228 can be configured to provide a color recommendation in response to a visual evaluation score that does not achieve the visual threshold.

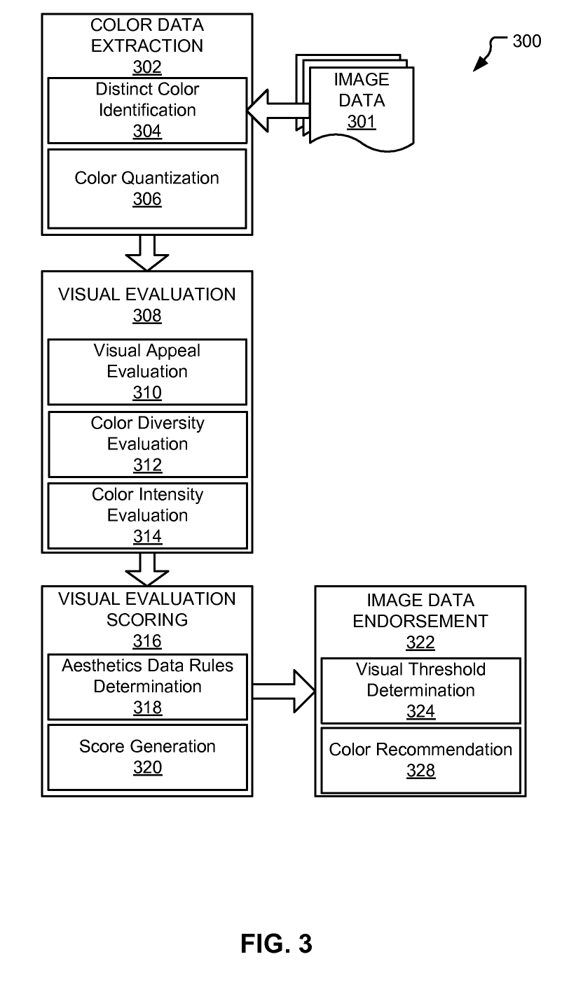

Referring now to FIG. 3 a system architecture 300 for visual evaluation can be seen according to embodiments of the present disclosure. In embodiments, the system architecture 300 represents an example architecture for executing embodiments of the present disclosure. For example, in some instances, the system architecture 300 can be an example representation of a portion of the system architecture 200 (FIG. 2) for aesthetics data evaluation. In some instances, the system architecture 300 can be an example representation of a portion of the aesthetics data evaluation application 113 (FIG. 1).

In embodiments, the system architecture 300 can include a color data extraction system 302, a visual evaluation system 308, a visual evaluation scoring system 316, and an image data endorsement system 322.

The color data extraction system 302 can be configured to identify color data from image data 301 for evaluation, scoring and possible endorsement by various systems and modules of the system architecture 300. The color data extraction system 302 can include a distinct color identification module 304 and a color quantization module 306.

The distinct color identification module 304 can be configured to access image data 301 and identify a set of distinct colors from the image data 301. In embodiments, the distinct color identification module 304 can identify the set of distinct colors based on an RGB color model. In certain embodiments other color models could be used including, but not limited to, CMYK, HSV (hue-saturation-value), and HSL (hue-saturation-lightness). In certain embodiments, the distinct color identification module 304 can be configured to determine the relative proportion of each distinct color in the set of image data. In embodiments, the set of distinct colors can be a set of color composition data.

The color quantization module 306 can be configured to generate a set of quantized colors from the set of image data 301. Color quantization can improve evaluation speed and reduce complexity in the system architecture 300 by combining similar colors from the set of image data 301 to reduce the total number of colors evaluated. In embodiments, the color quantization module 306 can use an octree structure-based color quantization approach to generate the set of quantized colors.

In embodiments, the color quantization module 306 can be configured to generate a set of quantized colors from the set of distinct colors. In embodiments, the proportions of distinct colors that are quantized can be combined accordingly, as designated as the proportion of the quantized color.

In certain embodiments, colors in the set of color data can be named based on a color value-color name mapping table. In embodiments, the naming of the set of color data can assist in evaluation of the set image data 301, described further herein.

For example, in embodiments, the distinct color identification module 304 could receive image data 301 representing a vegetable salad. From the image data 301, the distinct color identification module 304 could identify a set of around fifty distinct colors including shades of orange, red, yellow, and blue. For example, the shades of yellow could include gold, tan, and beige and the shades of red could include crimson, cherry and pink. Additionally, the distinct color identification module 304 could determine that the distinct colors had relative proportions in the set of image data 301 of 7% beige, 5% cherry, 15% crimson, 3% gold, 4%, pink, and 10% tan.

The color quantization module 306 could perform color quantization of the set of distinct colors to reduce the total number of colors. For example, the shades of orange could be combined into a first color, the shades of red could be combined into a second color, the shades of yellow could be combined into a third color, and the shades of blue could be combined into a fourth color. In embodiments, the relative proportions of quantized colors can be combined. For example, if the second color is formed from a combination of cherry, crimson, and pink it could have a relative proportion of around 24% (from the 4% pink, 5% cherry, and 15% crimson). In certain embodiments, the set of quantized colors can be named by the color data extraction system 302. For example, the first color could be named orange, the second color could be named red, the third color could be named yellow, and the fourth color could be named blue. In embodiments, the module 306 can assign names based on a name mapping table.

In embodiments, after color data, including a set of distinct colors and a set of quantized colors have been generated from the image data 301, the set of color data can be sent to the visual evaluation system 308.

The visual evaluation system 308 can be configured to evaluate the set of color data for eventual scoring and possible endorsement by various systems and modules in the system architecture 300. Described further herein, the visual evaluation system 308 can include a visual appeal evaluation module 310, a color diversity evaluation module 312, and a color intensity evaluation module 314.

The visual appeal evaluation module 310 can be configured to identify color parameters in the set of color data. For example, in embodiments, the visual appeal evaluation module 310 can be configured to identify one or more color schemes in the set of color data and/or particular types of colors such as warm colors and cool colors. In certain embodiments, the visual appeal evaluation module 310 could identify color schemes by analysis of the set of distinct colors. In certain embodiments, the visual appeal evaluation module 310 could identify color schemes by analysis of the set of quantized colors.

For example, in embodiments, the set of color data could include colors that can be categorized as warm colors and/or cool colors. In embodiments, the module 310 can identify analogous colors and complementary colors. In certain embodiments, the module 310 can identify split complementary color schemes and triad color schemes.

In embodiments the visual appeal evaluation module 310 can be configured to identify color schemes based on color angles or the hues of the set of distinct colors identified from the image data 301. For example, the visual appeal evaluation module 310 could identify a pair of complementary colors if the angles or hues between these two colors are approximately 180 degrees.

In certain embodiments, the visual evaluation system 308 can be assisted by the aesthetics data rules. For example, the visual appeal evaluation module 310 could determine that a particular color scheme is preferred based on the aesthetics data rules for the image data 301. For example, based on the aesthetics data rules, the visual appeal evaluation module 310 could determine that the presence of a complementary color scheme is highly preferred. In response, the visual appeal evaluation module 310 could be configured to seek out the complementary color scheme.

The color diversity evaluation module 312 can be configured to determine a color diversity parameter for the set of color data. The color diversity parameter can be a numerical representation of the variety of colors that make up the color data. For example, on a color wheel representation of a range of visible colors, the greater the radial distribution of colors in the color data on the color wheel, the greater the color diversity parameter.

In embodiments, the color diversity evaluation module 312 can measure the Euclidean distance between every two colors from the set of distinct colors in the Luv color space. The average of these distances can be used to indicate the color diversity of image data 301.

The color intensity evaluation module 314 can be configured to determine a color intensity parameter for the color data. In embodiments, the greater the intensity of colors in the color data the greater the color intensity parameter.

The color intensity evaluation module 314 can be configured to measure the means and standard deviations of two opponent colors in an opponent color space. These values can then be subsequently fused together to indicate the color intensity of image data 301.

The visual appeal parameters, the color diversity parameter, and the color intensity parameter can be used to determine a visual evaluation score for the color data in the visual evaluation scoring system 316.

The visual evaluation scoring system 316 can be configured to score color data for possible endorsement by various systems and modules in the system architecture 300. In embodiments, the visual evaluation scoring system can include an aesthetics data rules determination module 318, and a score generation module 320.

The aesthetics data rules determination module 318 can be the same or substantially similar as described herein with reference to the aesthetics data rules determination module 218 (FIG. 2). The score generation module 320 can be configured to generate a visual evaluation score for the data evaluated by the various systems and modules in the system architecture 300.

As described herein, the visual evaluation score can be generated based on aesthetic characteristics identified by the visual evaluation module 308 and based on the aesthetics data rules. In embodiments, the more aesthetics preferences satisfied by the set of color data, the higher the visual evaluation score generated by the score generation module 320.

For example, the aesthetic preferences could include a warm and cool color preference, an analogous color preference, and a complementary color preference. In embodiments, if just one aesthetic preference is met then the score generation module 320 could output a relatively low score. In embodiments, if two aesthetic preferences are met then the score generation module 320 could output a medium score. In embodiments, if three or more aesthetic preferences are met then the score generation module 320 could output a relatively high score.

For example, for a set of quantized colors including colors orange, red, yellow, and blue, the visual evaluation system 308 could identify aesthetic characteristics of warm colors (orange), cool colors (blue), complementary colors (orange and blue), and analogous colors (orange and red). The score generation module 320 could identify that three or more of the aesthetic preferences are satisfied and could output a relatively high score as a result.

In embodiments, after color data from the image data 301 has been scored by the visual evaluation scoring system 316, the image data 301 can then be sent to the image data endorsement system 322.

The image data endorsement system 322 can be configured to endorse or reject the image data 301 based on the evaluation and scoring of the set of color data by various systems and modules in the system architecture 300. The image data endorsement system 322 can include a visual threshold determination module 324 and a color recommendation module 328.

The visual threshold determination module 324 can compare the visual evaluation scores generated by the visual evaluation scoring system 316 to a visual threshold. In embodiments, the module can be configured to endorse the set of image data 301 in response to determining that the visual evaluation score achieves the visual threshold. In certain embodiments, the module can be configured to reject the image data 301 if the visual evaluation score does not achieve the visual threshold.

In embodiments, if the set of image data from the image data 301 has been rejected by the image data endorsement system 322, the image data 301 can be sent to the color data recommendation module 328. Described further herein, the color recommendation module 328 can determine a recommended set of color data based on the image data 301 and/or the aesthetics data rules.

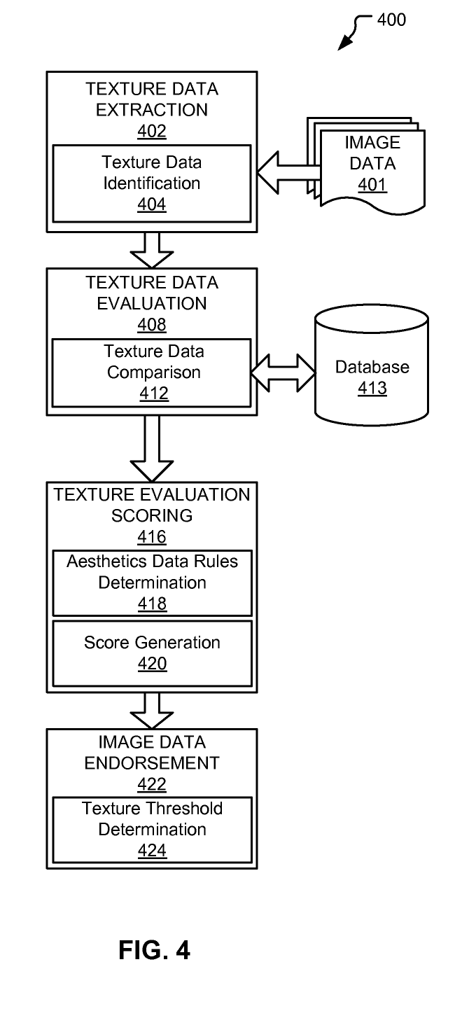

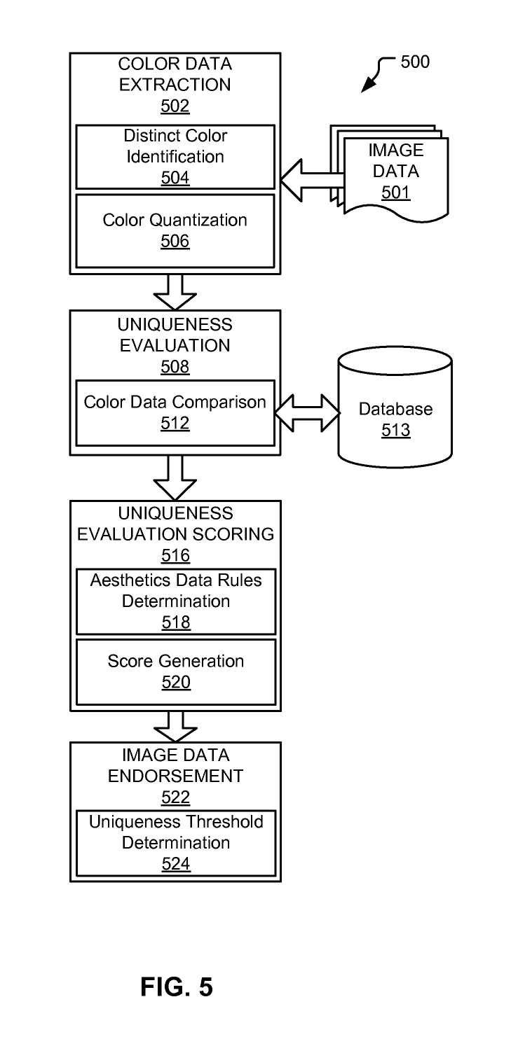

In some embodiments, the image data endorsement system 322 can operate with the image data endorsement system 422 (FIG. 4) and/or the image data endorsement system 522 (FIG. 5). For example, in embodiments, the image data endorsement system 322 could be configured to endorse the set of image data 301 in response to determining that the uniqueness evaluation score achieves the uniqueness threshold, determining that the visual evaluation score achieves the visual threshold, and determining that the texture evaluation score achieves the texture threshold.

Referring now to FIG. 4 a system architecture 400 for texture data evaluation can be seen according to embodiments of the present disclosure. In embodiments, the system architecture 400 can represent an example architecture for executing embodiments of the present disclosure. For example, in some instances, the system architecture 400 can be an example representation of a portion of the system architecture 200 (FIG. 2) for aesthetics data evaluation. In some instances, the system architecture 400 can be an example representation of a portion of the aesthetics data evaluation application 113 (FIG. 1).

In embodiments, the system architecture 400 can include a texture data extraction system 402, a texture data evaluation system 408, a texture evaluation scoring system 416, and an image data endorsement system 422.

The texture data extraction system 402 can be configured to identify texture data from the image data 401. The texture data extraction system 402 can include a texture data identification module 404.

The texture data identification module 404 can be configured to access the set of image data 401 and identify from the set of image data 401 one or more texture parameters. Texture parameters can include various features of the set of image data 401 that can be used to describe texture characteristics. In embodiments, the texture parameters can include, but are not limited to, measurements of coarseness, directionality, Gabor, and edge identification.

For example, in embodiments, the texture data identification module 402 can be used to apply Sobel edge detection to find edges in the set of image data 401. In embodiments, the texture data identification module 402 can calculate the average magnitude of edge points and indicate it as the texture parameter of image data 401.

For example, in embodiments, the texture data identification module 402 could access a set of image data 401 representing a bolt of silk fabric with a plaid pattern. From the image data 401, the texture data identification module 404 could identify texture parameters from the image. The texture data extraction module could identify a low coarseness measurement large values on directionality, Gabor and edge measurements.

The texture data evaluation system 408 can be configured to analyze the set of texture data identified from the image data 401. The texture data evaluation system 408 can include a texture data comparison module 412.

The texture data evaluation system 408 can be configured to evaluate the consistency of texture data from the image data 401. To evaluate texture, the system 408 can be configured to compare image data 401 to a repository of images to determine a texture difference. Based on the texture difference between the image data 401 and the repository, the system 408 can evaluate the consistency of the image data 401 relative to the repository. In embodiments, the repository includes a plurality of images that are related to the image data 401. For example, if the image data 401 is a picture of food, the repository can include texture data from other food related images. Additionally, if the image data 401 is a picture of a webpage, the repository could include texture data from webpage related images. Comparing image data 401 to a related repository of images can be more desirable, as it can provide a more accurate evaluation of texture of the image data 401.

In embodiments, a database 413 could store texture data from the repository of images. For example, in embodiments, database 413 could include texture data from around five hundred images of various types of foods. The texture evaluation system 408 could be configured to determine a texture difference between texture data identified from the image data 401 and some portion of the texture data from images in the database 413.

The texture data evaluation system 408 can include a texture data comparison module 412. In embodiments, the texture data comparison module 412 can be configured to compare various texture parameters from the image data 401 to texture parameters from the repository to determine the texture difference.

In embodiments, the texture data from the repository is an aggregation of texture data from the plurality of images in the repository.

In embodiments, the texture difference is determined by comparing texture parameters between the set of texture data from the set of image data 401 and texture data from the repository. For example, the Euclidean distance can be applied to measure the difference between the two sets of texture data by comparing and summing up the squared difference between the respective texture features. Described further herein, the texture difference can be used, in part, to determine a texture evaluation score for the image data 201.

After evaluation, the set of image data 401 can be scored by the texture evaluation scoring system 416. The texture evaluation scoring system 416 can be configured to score texture data from the image data 401. In embodiments, the texture evaluation scoring system can include an aesthetics data rules determination module 418, and a score generation module 420.

The aesthetics data rules determination module 418 can be the same or substantially similar as described herein with reference to the aesthetics data rules determination module 218 (FIG. 2). The score generation module 420 can be configured to generate a texture evaluation score for the image data 401. In embodiments, the texture evaluation score can be generated based on the texture difference determined by the texture evaluation system 408 and based on the aesthetics data rules.

For example, in embodiments, the aesthetics data rules could have a texture difference preference that the difference between the texture data generated from image data 401 and the database of texture data be relatively small. Thus, the lower the texture difference the higher the texture evaluation score generated in the score generation module 420. In certain embodiments, the aesthetics data rules could include a texture difference preference that the difference between the image data 401 and the database of texture data be relatively high. Thus, in embodiments, the higher the texture difference the higher the texture evaluation score generated in the module 420.

In embodiments, after texture data from the image data 401 has been scored by the texture evaluation scoring system 416, the image data 401 can then be sent to the image data endorsement system 422.

The image data endorsement system 422 can be configured to endorse or reject the image data 401 based on the evaluation and scoring of the set of texture data. The image data endorsement system 422 can include a texture threshold determination module 424.

The texture threshold determination module 424 can compare the texture evaluation score generated by the texture evaluation scoring system 416 to a texture threshold. In embodiments, the module can be configured to endorse the set of image data 401 in response to determining that the texture evaluation score achieves the texture threshold. In certain embodiments, the module can be configured to reject the image data 401 if the texture evaluation score does not achieve the texture threshold.

In some embodiments, the image data endorsement system 422 can operate with the image data endorsement system 322 (FIG. 3) and/or with the image data endorsement system 522 (FIG. 5). For example, in embodiments, the module 422 could be configured to endorse the set of image data 401 in response to determining that the uniqueness evaluation score achieves the uniqueness threshold, determining that the visual evaluation score achieves the visual threshold, and determining that the texture evaluation score achieves the texture threshold.

Referring now to FIG. 5 a system architecture 500 for uniqueness evaluation can be seen according to embodiments of the present disclosure. In embodiments, the system architecture 500 can represent an example architecture for executing embodiments of the present disclosure. For example, in some instances, the system architecture 500 can be an example representation of a portion of the system architecture 200 (FIG. 2) for aesthetics data evaluation. In some instances, the system architecture 500 can be an example representation of a portion of the aesthetics data evaluation application 113 (FIG. 1).

In embodiments, the system architecture 500 can include a color data extraction system 502, a uniqueness evaluation system 508, a uniqueness evaluation scoring system 516, and an image data endorsement system 522.

The color data extraction system 502 can be configured to identify color data from the set of image data 501 for evaluation, scoring and possible endorsement by various systems and modules of the system architecture 500. The color data extraction system 502 can include a distinct color identification module 504 and a color quantization module 506.

The distinct color identification module 504 can be configured to receive as set of image data 501 and identify a set of distinct colors from the image data 501. The distinct color identification module 504 can be the same or substantially similar as the distinct color identification module 304 (FIG. 3).

The color quantization module 506 can be configured to generate a set of quantized colors from the set of image data 501 as described herein. For example, in embodiments, the color quantization module 506 can be configured to quantize the set of distinct colors to a set of twelve quantized colors. The color quantization module 506 can be the same or substantially similar as the color quantization module 306 (FIG. 3).

The uniqueness evaluation system 508 can be configured to evaluate the uniqueness of color data from the image data 501. To evaluate uniqueness, the system 508 can be configured to compare image data 501 to a repository of image data to determine a color difference. Based on the color difference between the image data 501 and the repository, the system 508 can evaluate the uniqueness of the image data 501 relative to the repository. In embodiments, the repository includes a plurality of images that are related to the image data 501. For example, if the image data 501 is a picture of food, the repository of color data could be from other food related images. Additionally, if the image data 501 is a picture of a webpage, the repository of color data could be from webpage related images. Comparing image data 501 to a related repository of images can be more desirable, as it can provide a more accurate evaluation of uniqueness of the image data 501.

In embodiments, a database 513 could store color data from the repository of images. For example, in embodiments, database 513 could include color data from around five hundred images of various types of foods. The uniqueness evaluation system 508 could be configured to determine a difference between color data extracted from the image data 501 and some portion of the color data from images in the database 513.

The uniqueness evaluation system 508 can include a color data comparison module 512. In embodiments, the color data comparison module 512 can be configured to compare various color data from the image data 501 to color data from the repository to determine the color difference.

In embodiments, the color data in the image data 501 can include the set of distinct colors and the set of quantized colors, as described above. The set of distinct colors can include each color in the image data and its proportion in the image data 501. In embodiments, the set of distinct colors can be denoted as <c, r>, where c is a color in the set and r is the proportion in the image data 501.

The set of quantized colors can include each quantized color generated from the image data and its proportion in the image data 501. In embodiments, the set of quantized colors can be denoted as <qc, qr>, where qc is a color in the set and qr is the proportion in the image data 501.

In embodiments, the color data from the repository is an aggregation of color data from the plurality of images in the repository. For example, color data from the repository can include an amalgamated set of distinct colors and an amalgamated set of quantized colors. The amalgamated set of distinct colors could include each color in the repository, its average proportion in images, the standard deviation of proportions, and the percentage of images that have this color. In embodiments, the amalgamated set of distinct colors can be denoted as <rc, mr, sr, p> where rc is a color in the set, mr is its average proportion in images, sr is the standard deviation of proportions, and p is the percentage of images that have the color.

The amalgamated set of quantized colors could include each quantized color in the repository, its average proportion in images, the standard deviation of proportions, and the percentage of images that have this color. In embodiments, the amalgamated set of quantized colors can be denoted as <qrc, qmr, qsr, qp> where qc is a color in the set, qmr is its average proportion in images, qsr is the standard deviation of proportions, and qp is the percentage of images that have the color.

In certain embodiments, the color data comparison module 512 can be configured to determine the color distance based on a Mahalanobis distance between the color data extracted from the image data 501 and color data from the repository.

In some embodiments, the color data comparison module 512 could determine the color difference between the color data in image data 501 (A) and the amalgamated color data in Repository (R) according to the following equation:

U^{AR}=w₁×CD^{AR}+(1−w₁)×QCD^{AR}

Where U^{AR} is the color difference, w₁ is a weight, CD^{AR} is the difference between the set of distinct colors in image data 501 and the amalgamated set of distinct colors from the repository, and QCD^{AR} is the difference between the set of quantized colors from image data 501 and the amalgamated set of quantized colors from the repository.

In some embodiments, the color data comparison module 512 could determine CD^{AR} according to the following equation:

CD^{AR}=(1−E^{AR})+N^{AR}

Where E^{AR} indicates the similarity between A and R for colors that exist in both the image data 501 and the repository, and N^{AR} measures the dissimilarity for colors that are only found in image data 501.

In some embodiments, the color data comparison module 512 could determine E^{AR} according to the following equation:

$${E}^{AR} = {\sum }_{i} ( 1 - \vert \frac{{r}^{i} - {mr}^{i}}{{sr}^{i}} \vert ) \times {p}^{i}$$

Where i indicates that variables are for colors that exist in both A and R. Note that in the algorithm for E^{AR}, pⁱ is normalized so that E^{AR} is a value within [0, 1]

In some embodiments, the color data comparison module 512 could determine N^{AR} according to the following algorithm:

N^{AR}=Σⱼr^{j}

Where j indicates that the variables are for colors that exist in A and not in R.

In some embodiments, the color data comparison module 512 could determine QCD^{AR} according to the following equation:

QCD^{AR}=(1−QE^{AR})+QN^{AR}

Where QE^{AR} indicates the similarity between A and R for quantized colors that exist in both the image data 501 and the repository, and N^{AR} measures the dissimilarity for quantized colors that are only found in image data 501.

In some embodiments, the color data comparison module 512 could determine QE^{AR} according to the following equation:

$$Q {E}^{AR} = {\sum }_{i} ( 1 - \vert \frac{q {r}^{i} - q m {r}^{i}}{q s {r}^{i}} \vert ) \times {p}^{i}$$

Where i indicates that variables are for quantized colors that exist in both A and R. Note that in the algorithm for QE^{AR}, pⁱ is normalized so that QE^{AR} is a value within [0, 1]

In some embodiments, the color data comparison module 512 could determine QN^{AR} according to the following algorithm:

QN^{AR}=Σⱼqr^{j}

Where j indicates that the variables are for quantized colors that exist in A and not in R.

Based on the color difference U^{AR}, the color data extracted from image data 501 can be scored by the uniqueness evaluation scoring system 516.

The uniqueness evaluation scoring system 516 can be configured to score color data from the image data 501 for possible endorsement by various systems and modules in the system architecture 500. In embodiments, the uniqueness evaluation scoring system 516 can include an aesthetics data rules determination module 518, and a score generation module 520.

The aesthetics data rules determination module 518 can be the same or substantially similar as described herein with reference to the aesthetics data rules determination module 218 (FIG. 2). In embodiments, the aesthetics data rules can include a uniqueness preference that sets a preferred value for the color difference. For example, in some embodiments, the aesthetics data rules could include a preference that the colors in image data 501 be relatively unique. Thus, the uniqueness preference will include a high value for the color difference. In certain embodiments, the aesthetics data rules could include a preference that the colors in image data 501 be relatively non-unique. Thus, the uniqueness preference could include a low value for the color difference.

The score generation module 520 can be configured to generate a uniqueness evaluation score for the color data. The uniqueness evaluation score can be generated based on the color difference and the aesthetics data rules. As described herein, the more aesthetic preferences met by the set of color data, the higher the generated visual evaluation score by the score generation module 520.

In embodiments, after color data from the image data 501 has been scored by the uniqueness evaluation scoring system 516, the image data 501 can then be sent to the image data endorsement system 522.

The image data endorsement system 522 can be configured to endorse or reject the image data 501 based on the evaluation and scoring of the set of color data by various systems and modules in the system architecture 500. The image data endorsement system 522 can include a uniqueness threshold determination module 524.

The uniqueness threshold determination module 524 can compare the uniqueness evaluation score generated by the uniqueness evaluation scoring system 516 to a uniqueness threshold. In embodiments, the module can be configured to endorse the set of image data 501 in response to determining that the uniqueness evaluation score achieves the uniqueness threshold. In certain embodiments, the module can be configured to reject the set of image data 501 if the uniqueness evaluation score does not achieve the uniqueness threshold.

In some embodiments, the image data endorsement system 522 can operate with the image data endorsement system 322 (FIG. 3) and/or the image data endorsement system 422 (FIG. 4). For example, in embodiments, the module 522 could be configured to endorse the set of image data 501 in response to determining that the uniqueness evaluation score achieves the uniqueness threshold, determining that the visual evaluation score achieves the visual threshold, and determining that the texture evaluation score achieves the texture threshold.

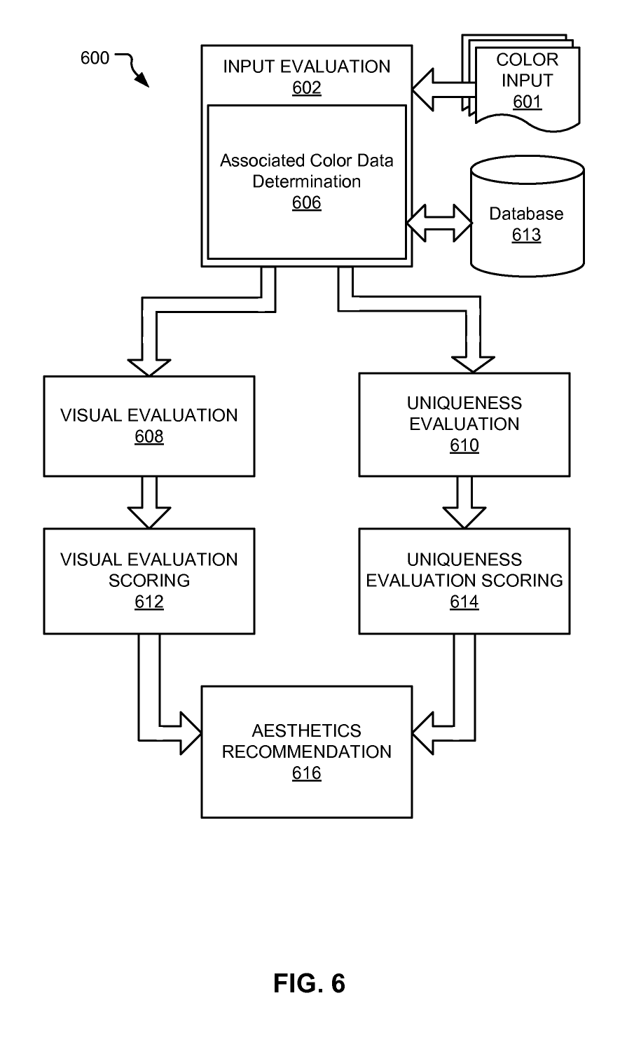

Referring now to FIG. 6, a system architecture 600 for aesthetics recommendation can be seen according to embodiments of the present disclosure. In embodiments, the system architecture 600 can represent an example architecture for executing embodiments of the present disclosure. For example, in some instances, the system architecture 600 can be an example representation of a portion of the system architecture 200 (FIG. 2) for aesthetics data evaluation. For example, in some instances the system architecture 600 could be an example of the aesthetics recommendation module 228 (FIG. 2) and/or the color recommendation module 328 (FIG. 3). In some instances, the system architecture 600 can be an example representation of a portion of the aesthetics data evaluation application 113 (FIG. 1).

The system architecture 600 can include an input evaluation system 602, a visual evaluation system 608, a uniqueness evaluation system 610, a visual evaluation scoring system 612, a uniqueness evaluation scoring system 614, and an aesthetics data recommendation system 616.

The input evaluation system 602 can be configured to receive a color data input 601 and determine a set of recommended color data based on the color data input 601. The color data input 601 can be one or more individual colors. Based on the color data input 601, the input evaluation system 602 can determine a set of associated color data that can be scored for possible endorsement and recommendation by various systems and modules of the system architecture 600.

In embodiments, the color data input 601 can be selected by a user. In certain embodiments the color data input 601 can be selected automatically. For example, in embodiments, the color data input 601 could be selected as a set of color data from a set of image data 301 (FIG. 3) rejected by the image data endorsement system 322. Input evaluation system 602 can include an associated color data determination module 606.

The associated color data determination module 606 can be configured to determine a set of color data that is associated with the color data input 601. In embodiments, a set of color data is associated with the color data input 601 based on the frequency with which color data is present with the input color data 601. In embodiments, the module 606 can use a repository of color data to determine which colors are associated with the color data input 601.

The repository can include a plurality of color data from a plurality of image data. In embodiments, the repository can be related to a particular image. For example, in embodiments, the repository can include color data for images related to food. In certain examples, the repository could include color data for images related to fashion. In embodiments, a user could select the repository. For example, the user could select a repository related to food to determine a set of associated color data based on color data related to food. Thus, if the user wanted a color recommendation for the color data input 601 in the realm of food aesthetics, the user could select a repository related to food. In embodiments, a database 613 can store the repository for access by the input evaluation system 602.

For example, if the color data input 601 is red, the associated color data determination module 606 could determine that the color maroon is present with the color red in the thirty percent of color data in the repository. The percentage measuring the presence of a particular color with the input color data 601 is referred to herein as a “presence percentage” Based on the presence percentage, the module 606 can determine that maroon is associated with red. For example, in embodiments, the module 606 can compare the presence percentage to a threshold to determine whether the color data is associated with the input color data 601. In embodiments, the module 606 can determine a set of associated color data from color data in the repository which has a presence percentage that achieves the threshold.

In embodiments, after the set of associated color data has been determined by the module 606, the set can be evaluated and scored to determine whether it is a recommended set of color data. In embodiments, the set of associated color data can be endorsed based on a visual evaluation score and a uniqueness evaluation score as described herein.

The visual evaluation system 608 and visual evaluation scoring system 612 can be the same or substantially similar as the systems 308, 316 described in reference to FIG. 3. The uniqueness evaluation system 610 and the uniqueness evaluation scoring system 614 can be the same or substantially similar as the systems 508, 516 described in reference to FIG. 5. The systems can be configured to evaluate, and score the set of associated color data, as described herein.

The aesthetics recommendation system 616 can be configured to endorse or reject the set of associated color data as a set of recommended color data. In embodiments, if the a visual evaluation score for the set of associated color data achieves a visual threshold, and a uniqueness evaluation score for the set of associated color data achieves a uniqueness threshold, then the aesthetics recommendation system 616 can endorse the set of associated color data as a recommended set of color data.

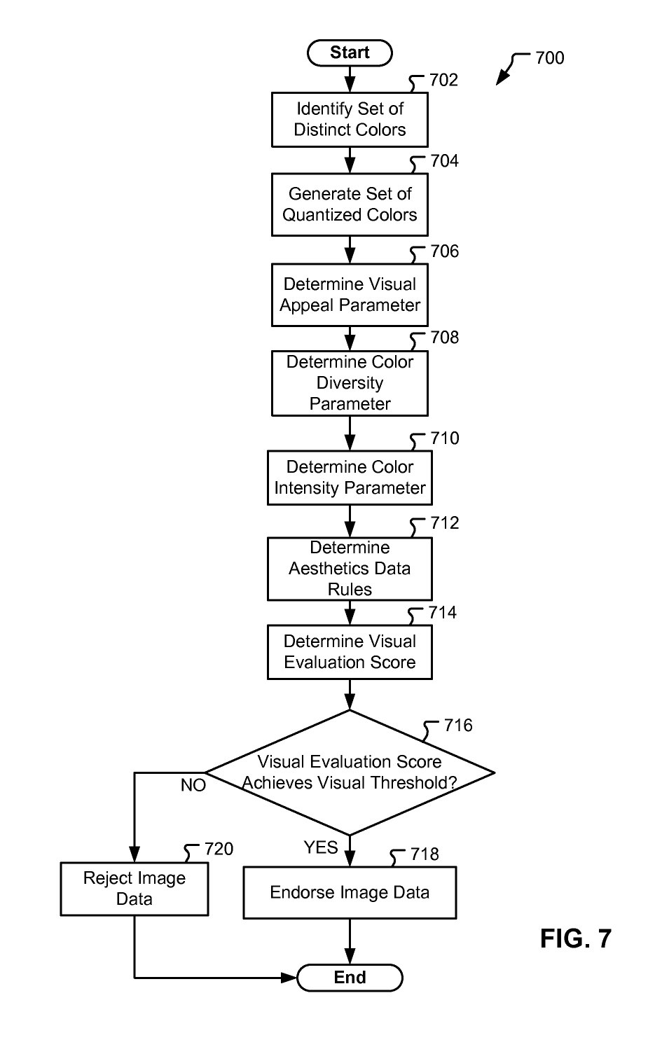

Referring now to FIG. 7, a flow chart diagram of a method 700 of visual evaluation can be seen according to embodiments of the present disclosure. In operation 702 a set of distinct colors can be identified. The set of distinct colors can be the same or substantially similar as described herein. The set of distinct colors can be identified from a set of image data. In operation 704, a set of quantized colors can be generated. In embodiments, the set of quantized colors can be generated as described herein.

In operation 706, visual appeal parameters can be identified. In embodiments identifying visual appeal parameters includes identifying color schemes. In embodiments, identifying visual appeal parameters includes identifying particular types of colors, such as warm colors and cool colors. In embodiments, the visual appeal parameters can be identified from a set of color data.

In operation 708 a color diversity parameter can be determined. The color diversity parameter can be determined from the set of color data. The color diversity parameter can be the same or substantially similar as described herein. In operation 710, a color intensity parameter can be determined. The color intensity parameter can be determined from the set of color data. The color intensity parameter can be the same or substantially similar as described herein.

In operation 712, a set of aesthetics data rules can be determined. The set of aesthetics data rules can be the same or substantially similar as described herein. In embodiments, the set of aesthetics data rules can include one or more aesthetics preferences for image data. Based on the preferences the set of color data can be scored. In operation 714, a visual evaluation score can be determined. In embodiments, the visual evaluation score can be a color evaluation score for color data identified from a set of image data. The visual evaluation score can be determined in the same or substantially similar manner as described herein. If the visual evaluation score achieves a visual threshold, then in operation 716 image data from which the set of color data was extracted from can be endorsed in operation 718. If the visual evaluation score does not achieve the visual threshold then in operation 716 image data from which the set of color data was extracted from can be rejected in operation 720.

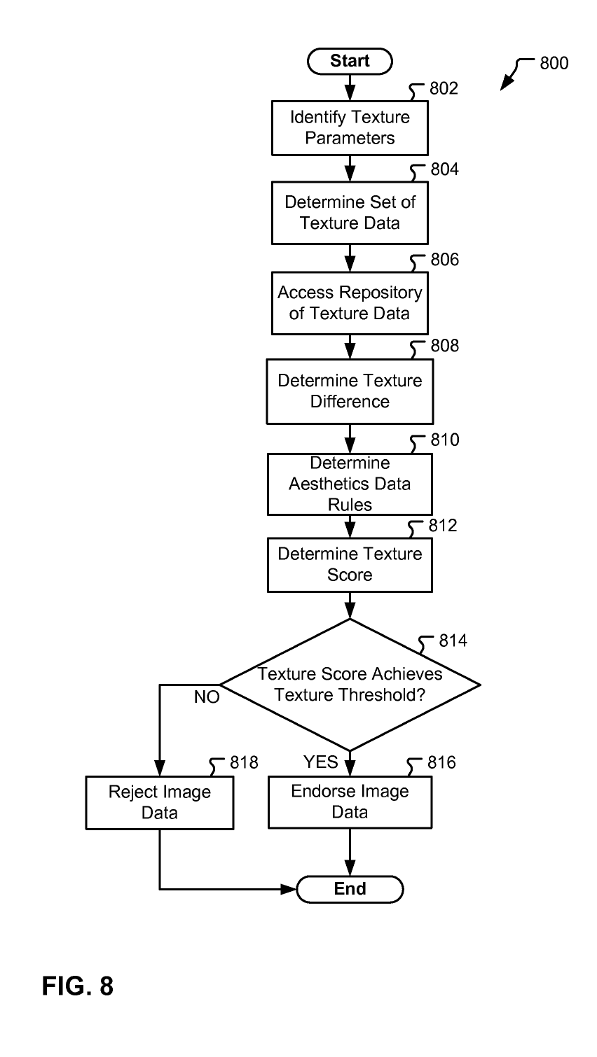

Referring now to FIG. 8, a flow chart diagram of a method 800 texture data evaluation can be seen according to embodiments of the present disclosure. In operation 802, a set of texture parameters can be identified. The set of texture parameters can be identified from a set of image data. The set of texture parameters can be the same or substantially similar as described herein. In operation 804, a set of texture data can be determined. The set of texture data can be the same or substantially similar as described herein. In operation 806, a repository of texture data can be access. The repository of texture data can include a set of texture data amalgamated from a plurality of images, as described herein. In operation 808 a texture difference can be determined. In embodiments, the texture difference can be a difference between the set of texture data and texture data in the repository, as described herein.

In operation 810, a set of aesthetics data rules can be determined. The aesthetics data rules can be the same or substantially similar as described herein. In embodiments, the set of aesthetics data rules can include one or more aesthetics preferences for image data. Based on the preferences the set of texture data can be scored. In operation 812, a texture evaluation score can be determined. The texture evaluation score can be determined in the same or substantially similar manner as described herein. If the texture evaluation score achieves a texture threshold, then in operation 814 image data from which the set of texture data was extracted from can be endorsed in operation 816. If the texture evaluation score does not achieve the texture threshold then in operation 814 image data from which the set of texture data was extracted from can be rejected in operation 818.

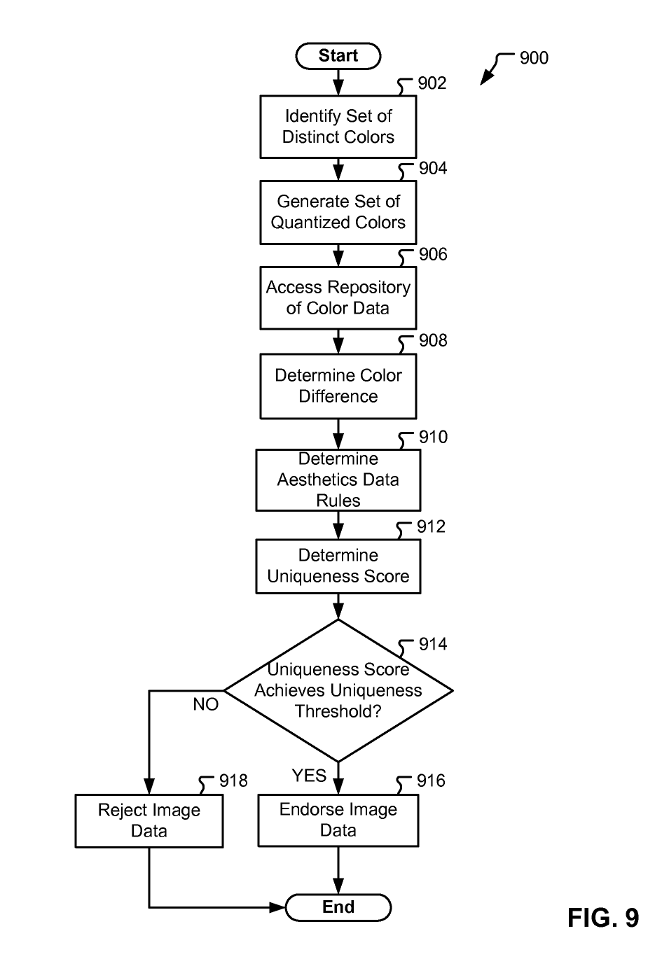

Referring now to FIG. 9, a flow chart diagram of a method 900 of uniqueness evaluation can be seen according to embodiments of the present disclosure. In operation 902 a set of distinct colors can be identified from a set of image data. The set of distinct colors can be the same or substantially similar as described herein. In operation 904, a set of quantized colors can be generated. In embodiments, the set of quantized colors can be generated as described herein.

In operation 906, a repository of color data can be accessed. The repository of color data can include a set of color data amalgamated from a plurality of images, as described herein. In operation 908 a color difference can be determined. The color difference can be determined in the same or substantially similar manner as described herein. In operation 910, a set of aesthetics data rules can be determined. The set of aesthetics data rules can be the same or substantially similar as described herein. In embodiments, the set of aesthetics data rules can include one or more aesthetics preferences for image data. Based on the preferences the set of color data can be scored.

In operation 912, a uniqueness evaluation score can be determined. The uniqueness evaluation score can be determined in the same or substantially similar manner as described herein. If the uniqueness evaluation score achieves a uniqueness threshold, then in operation 914 image data from which the set of color data was extracted from can be endorsed in operation 916. If the uniqueness evaluation score does not achieve the uniqueness threshold then in operation 914 image data from which the set of color data was extracted from can be rejected in operation 918.

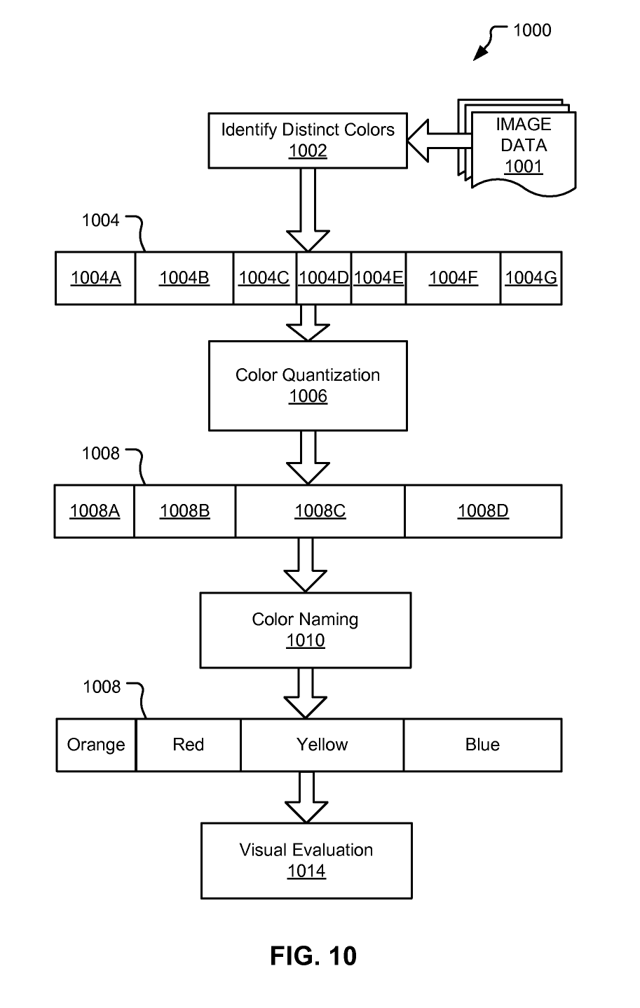

Referring now to FIG. 10, a diagram 1000 of color data identification can be seen, according to embodiments of the present disclosure. In embodiments, the diagram 1000 can depict color identification that is performed by the color data extraction system 302 (FIG. 3), as described herein.

In module 1002 of the diagram 1000, a set of distinct colors 1004 can be identified from a set of image data 1001. The set of distinct colors 1004 and the set of image data 1001 can be the same or substantially similar as described herein. The set of distinct colors 1004 can include colors 1004A-1004G represented by boxes having varying proportions. In diagram 1000, the proportion of each color 1004A-1004G is represented by the size of each color's respective box in the set of distinct colors 1004. For example, color 1004B has a larger box than color 1004C. Thus color 1004B has a larger proportion in the set of distinct colors 1004 than color 1004C.

In module 1006 of the diagram 1000, the set of distinct colors 1004 can be quantized into a set of quantized colors 1008. The set of quantized colors 1008 can be the same or substantially similar as described herein. The set of quantized colors 1008 can include quantized colors 1008A-1008D. As described herein, the quantized colors 1008A-1008D can be formed based on color quantization to reduce the total number of distinct colors by combining colors which are similar.

For example, as seen in FIG. 10, module 1006 has combined colors 1004C-1004E into quantized color 1008C. Similarly, colors 1004F and 1004G have been combined into quantized color 1008D.

In addition, the proportions of quantized colors 1008A-1008D have been altered, relative to colors 1004A-1004G, to reflect the combination of certain colors. For example, while colors 1004C-1004E each had a relatively small proportion in the set of distinct colors 1004, quantized color 1008C has a larger proportion to reflect that quantized color 1008C was formed from a combination of colors 1004C-1004E.

In module 1010 of the diagram 1000, the set of quantized colors 1008 can be assigned color names. The set of quantized colors 1008 can be the same or substantially similar as described herein. In embodiments, the set of quantized colors 1008 can have names assigned to individual quantized colors 1008A-1008D to assist in visual evaluation of the set of quantized colors. For example, color names can assist a system in identifying aesthetic characteristics such as color schemes and other aesthetics data. As seen in FIG. 10, the set of quantized colors can include named colors such as, orange, red, yellow and blue. In embodiments, the module 1010 can assign color names based on a RGB color model. In certain embodiments, the module 1010 can assign color names based on other suitable color models.

In module 1014 of the diagram 1000, the set of quantized colors 1008 can be sent for visual evaluation. Visual evaluation can be the same or substantially similar as the visual evaluation system 308 (FIG. 3).

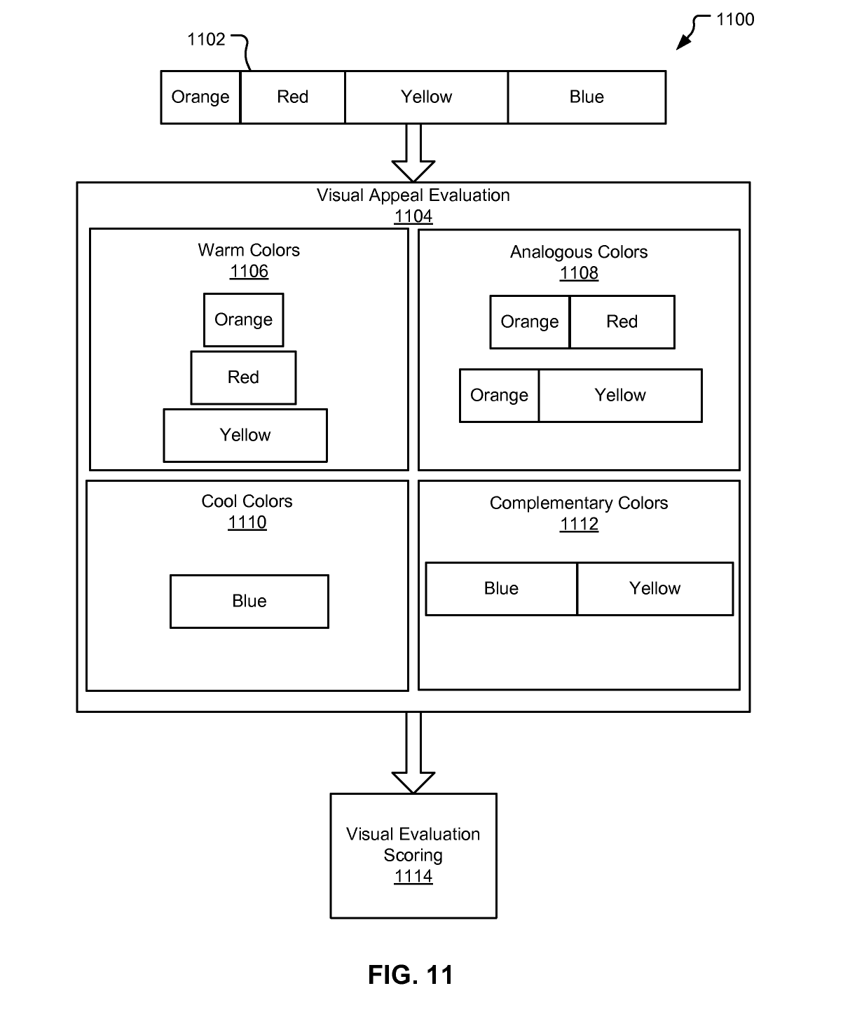

Referring now to FIG. 11, a diagram 1100 of visual appeal evaluation can be seen, according to embodiments of the present disclosure. In embodiments, the diagram 1100 can depict visual appeal evaluation performed by the visual evaluation system 308 (FIG. 3), as described herein.

In module 1104 of the diagram 1100, a set of quantized colors 1102 can be evaluated for various visual appeal parameters. The set of quantized colors 1102 can be the same or substantially similar as described herein. As seen in FIG. 11, the set of quantized colors 1102 can include various colors including orange, red, yellow, and blue. In embodiments, the module 1104 can be configured to identify various color schemes and various types of colors including, but not limited to, warm colors 1106, analogous colors 1108, cool colors 1110, and complementary colors 1112.

In embodiments, based on the angles of colors in the set of quantized colors 1102, the module 1104 can identify colors schemes present in the set of quantized colors. For example, based on the colors in the set of quantized colors 1102, the module 1104 could identify that warm colors 1106 of orange, red, and yellow are present. The module 1104 could identify that analogous colors 1108 of orange and red, and orange and yellow are present. The module 1104 could identify that cool color 1110 of blue is present. The module 1104 could identify that complementary colors 1112 of blue and yellow are present.

In module 1114 of the diagram 1100, the identified color schemes can be used for visual evaluation scoring. Visual evaluation scoring can be the same or substantially similar as the visual evaluation scoring system 316 (FIG. 3). Based on the aesthetics data rules and the identified color schemes, the module 1114 can generate a visual evaluation score indicating the relative aesthetic appeal of the set of image data from which the set of quantized colors 1102 originated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method of evaluating aesthetics of image data, the method comprising:
identifying a first set of aesthetics data from a first set of image data;
generating an aesthetics evaluation score for the first set of image data, the aesthetics evaluation score generated based on the first set of aesthetics data and a first set of aesthetics data rules;
determining that the aesthetics evaluation score achieves an aesthetics threshold; and
endorsing the first set of image data in response to determining that the aesthetics evaluation score achieves the aesthetics threshold.

2. The method of claim 1, further comprising:
identifying a second set of aesthetics data from a second set of image data;
generating an aesthetics evaluation score for the second set of image data, the aesthetics evaluation score for the second set of image data generated based on the second set of aesthetics data and a second set of aesthetics data rules;
determining that the aesthetics evaluation score for the second set of image data does not achieve the aesthetics threshold; and
rejecting the second set of image data in response to determining that the aesthetics evaluation score for the second set of image data does not achieve the aesthetics threshold.

3. The method of claim 2, wherein:
the first set of aesthetics data rules and the second set of aesthetics data rules are the same.

4. The method of claim 2, further comprising:
determining a third set of aesthetics data;
determining that an another aesthetics evaluation score generated based on a combination of the third set of aesthetics data and the second set of aesthetics data, and generated based on the second set of aesthetics data rules, achieves the aesthetics threshold; and
presenting the third set of aesthetics data in response to determining that the another aesthetics evaluation score generated based on the combination achieves the aesthetics threshold.

5. The method of claim 1, wherein:
the first set of aesthetics data includes a first set of color data;
generating the aesthetics evaluation score for the first set of image data includes:
generating a visual evaluation score for the first set of image data, the visual evaluation score generated based on the first set of color data and the first set of aesthetics data rules;
determining that the aesthetics evaluation score achieves the aesthetics threshold includes:
determining that the visual evaluation score achieves a visual threshold; and
wherein endorsing the first set of image data includes:
endorsing the first set of image data in response to determining that the visual evaluation score achieves the visual threshold.

6. The method of claim 5, wherein:
generating the visual evaluation score based on the first set of color data and the first set of aesthetics data rules includes:
identifying a visual appeal parameter in the first set of color data;
determining a color diversity parameter for the first set of color data;
determining a color intensity parameter for the color data; and
determining the visual evaluation score further based on the visual appeal parameter, the color diversity parameter, and the color intensity parameter.

7. The method of claim 1, wherein:
the first set of aesthetics data includes a first set of texture data;
generating the aesthetics evaluation score for the first set of image data includes:
generating a texture evaluation score for the first set of image data, the texture evaluation score generated based on the first set of aesthetics data rules and generated based on a texture difference between the first set of texture data and a second set of texture data, the second set of texture data identified from a second set of image data;
determining that the aesthetics evaluation score achieves the aesthetics threshold includes:
determining that the texture evaluation score achieves a texture threshold; and
wherein endorsing the first set of image data includes:
endorsing the first set of image data in response to determining that the texture evaluation score achieves the texture threshold.

8. The method of claim 1, wherein:
the first set of aesthetics data includes a first set of color data;
generating the aesthetics evaluation score for the first set of image data includes:
generating a uniqueness evaluation score for the first set of image data, the uniqueness evaluation score based on the first set of aesthetics data rules and generated based on a color difference between the first set of color data and a second set of color data, the second set of color data extracted from a second set of image data;
determining that the aesthetics evaluation score achieves the aesthetics threshold includes:
determining that the uniqueness evaluation score achieves a uniqueness threshold; and
wherein endorsing the first set of image data includes:
endorsing the first set of image data further in response to determining that the uniqueness evaluation score achieves the uniqueness threshold.

9. The method of claim 1, further comprising:
receiving a color data input;
determining a second set of aesthetics data including the color data input;
determining that an another aesthetics evaluation score generated based on the second set of aesthetics data and generated based on the first set of aesthetics data rules achieves the aesthetics threshold; and
presenting the second set of aesthetics data in response to determining that the another aesthetics evaluation score generated based on the second set of aesthetics data and on the first set of aesthetics data rules achieves the aesthetics threshold.

10. A computer system of evaluating aesthetics of image data, the system comprising:
an aesthetics identification module configured to:
identify a first set of aesthetics data from a first set of image data; and
a processor configured to:
generate an aesthetics evaluation score for the first set of image data, the aesthetics evaluation score generated based on the first set of aesthetics data and a first set of aesthetics data rules;
determine that the aesthetics evaluation score achieves an aesthetics threshold; and
endorse the first set of image data in response to determining that the aesthetics evaluation score achieves the aesthetics threshold.

11. The system of claim 10, wherein:
the aesthetics identification module is further configured to:
identify a second set of aesthetics data from a second set of image data; and
wherein the processor is further configured to:
generate an aesthetics evaluation score for the second set of image data, the aesthetics evaluation score for the second set of image data generated based on the second set of aesthetics data and a second set of aesthetics data rules;
determine that the aesthetics evaluation score for the second set of image data does not achieve the aesthetics threshold; and
reject the second set of image data in response to determining that the aesthetics evaluation score for the second set of image data does not achieve the aesthetics threshold.

12. The system of claim 11, wherein:
the first set of aesthetics data rules and the second set of aesthetics data rules are the same.

13. The system of claim 11, wherein:
the processor is further configured to:
determine a third set of aesthetics data;
determine that an another aesthetics evaluation score, generated based on a combination of the third set of aesthetics data and the second set of aesthetics data, and generated based on the second set of aesthetics data rules, achieves the aesthetics threshold; and
present the third set of aesthetics data in response to determining that the another aesthetics evaluation score, generated based on the combination achieves the aesthetics threshold.

14. The system of claim 10, wherein:
the first set of aesthetics data includes a first set of color data;
wherein the processor being configured to generate the aesthetics evaluation score for the first set of image data includes being configured to:
generate a visual evaluation score for the first set of image data, the visual evaluation score generated based on the first set of color data and the first set of aesthetics data rules;
wherein the processor being configured to determine that the aesthetics evaluation score achieves the aesthetics threshold includes being configured to:
determine that the visual evaluation score achieves a visual threshold; and
wherein the processor being configured to endorse the first set of image data includes being configured to:
endorse the first set of image data in response to determining that the visual evaluation score achieves the visual threshold.

15. The system of claim 14, wherein:
the processor being configured to determine the visual evaluation score based on the first set of color data and the first set of aesthetics data rules includes being configured to:
identify a visual appeal parameter in the first set of color data;
determine a color diversity parameter for the first set of color data;
determine a color intensity parameter for the first set of color data; and
determine the visual evaluation score further based on the visual appeal parameter, the color diversity parameter, and the color intensity parameter.

16. The system of claim 10, wherein:
the first set of aesthetics data includes a first set of texture data;
wherein the processor being configured to generate the aesthetics evaluation score for the first set of image data includes being configured to:
generate a texture evaluation score for the first set of image data, the texture evaluation score generated based on the first set of aesthetics data rules and generated based on a texture difference between the first set of texture data and a second set of texture data, the second set of texture data identified from a second set of image data;
wherein the processor being configured to determine that the aesthetics evaluation score achieves the aesthetics threshold includes being configured to:
determine that the texture evaluation score achieves a texture threshold; and
wherein the processor being configured to endorse the first set of image data includes being configured to:
endorse the first set of image data further in response to determining that the texture evaluation score achieves the texture threshold.

17. The system of claim 10, wherein:
the first set of aesthetics data includes a first set of color data;
wherein the processor being configured to generate the aesthetics evaluation score for the first set of image data includes being configured to:
generate a uniqueness evaluation score for the first set of image data, the uniqueness evaluation score generated based on the first set of aesthetics data rules and generated based on a color difference between the first set of color data and a second set of color data, the second set of color data identified from a second set of image data;
wherein the processor being configured to determine that the aesthetics evaluation score achieves an aesthetics threshold includes being configured to:
determine that the uniqueness evaluation score achieves a uniqueness threshold; and
wherein the processor being configured to endorse the first set of image data includes being configured to:
endorse the first set of image data further in response to determining that the uniqueness evaluation score achieves the uniqueness threshold.

18. The system of claim 10, wherein:
the processor is further configured to:
receive a color data input;
determine a second set of aesthetics data including the color data input;
determine that an another aesthetics evaluation score generated based on the second set of aesthetics data and generated based on the first set of aesthetics data rules achieves the aesthetics threshold; and
present the second set of aesthetics data in response to determining that the another aesthetics evaluation score generated based on the second set of aesthetics data and generated based on the first set of aesthetics data rules achieves the aesthetics threshold.

19. A computer program product for evaluating aesthetics of image data, the computer program product comprising a computer readable storage medium having program instructions embodied therewith, the program instructions executable by a computer to cause the computer to perform a method comprising:
identifying a first set of aesthetics data from a first set of image data;
generating an aesthetics evaluation score for the first set of image data, the aesthetics evaluation score generated based on the first set of aesthetics data and a first set of aesthetics data rules;
determining that the aesthetics evaluation score achieves an aesthetics threshold; and
endorsing the first set of image data in response to determining that the aesthetics evaluation score achieves the aesthetics threshold.

20. The computer program product of claim 19, wherein the method further comprises:
identifying a second set of aesthetics data from a second set of image data;
generating an aesthetics evaluation score for the second set of image data, the aesthetics evaluation score generated based on the second set of aesthetics data and a second set of aesthetics data rules;
determining that the aesthetics evaluation score for the second set of image data does not achieve the aesthetics threshold; and
rejecting the second set of image data in response to determining that the aesthetics evaluation score for the second set of image data does not achieve the aesthetics threshold.
